(19) United States
(12) Patent Application Publication
(10) Pub. No.: US 2025/0058810 A1
(43) Pub. Date: Feb. 20, 2025

(54) CONNECTING STRUCTURE AND TRANSPORT CART

(71) Applicant: QINGDAO HUATIAN HAND TRUCK CO., LTD., Qingdao (CN)

(72) Inventor: ZHIJUN LIU, Qingdao (CN)

(21) Appl. No.: 18/650,723

(22) Filed: Apr. 30, 2024

(30) Foreign Application Priority Data
Aug. 15, 2023 (CN) 202322184239.6

(51) Int. Cl. B62B 3/02

(52) U.S. Cl. CPC B62B 3/02; B62B 2205/20

(57) ABSTRACT

Disclosed is a connecting structure, including: fixing components, a connecting shaft that is connected to the fixing components, a connecting sleeve that is sleeved on the connecting shaft, and pull rings and locking portions spaced apart from the pull rings on the connecting sleeve, where the pull rings are arranged around the connecting sleeve, and the pull rings extend along one side of the connecting sleeve away from the connecting shaft; the locking portion penetrates through the fixing component; the connecting sleeve and the connecting shaft are arranged in a relatively movable manner, so that the locking portion has a locked state of protruding from the fixing component and a contracted state of contracting inside the fixing component; and when the locking portion is in the locked state, the locking portion is connected to a to-be-connected component, so that the connecting structure is fixedly connected to the to-be-connected component.

### CROSS-REFERENCE TO RELATED APPLICATIONS

The application claims priority to Chinese patent application No. 202322184239.6, filed on Aug. 15, 2023, the entire contents of which are incorporated herein by reference.

### TECHNICAL FIELD

The present disclosure relates to the technical field of transport carts, and particularly relates to a transfer structure and a transport cart.

### BACKGROUND

In existing factories or logistics and warehousing workshops, transport carts are often used to transfer goods. As the turnover of goods within the workshop continuously increases, people also have increasing demand for the carrying capacity of transport carts. In existing workshops, large transport carts are generally used, or more transport carts are allocated to meet the carrying requirements.

However, as the size and number of transport carts increase, a new problem arises in the storage of transport carts. In the prior art, foldable transport carts are used, which can be conveniently stored when they are not in use. However, when in use, existing foldable transport carts usually lack a robust structure, thus resulting in deformation of the transport carts. Further, when in use, transport carts require switching states frequently, and operators need to exert considerable effort, thus reducing work efficiency.

Thus, the prior art is required to be further improved.

### SUMMARY

In order to overcome the above technical defects, the present disclosure provides a connecting structure and a transport cart to solve the technical problem of instability and inconvenience of operation of foldable transport carts in related art during use.

To achieve the above objective, the present disclosure adopts the following technical solution: a connecting structure, including: fixing components, a connecting shaft that is connected to the fixing components, a connecting sleeve that is sleeved on the connecting shaft, and pull rings and locking portions spaced apart from the pull rings on the connecting sleeve, where the pull rings are arranged around the connecting sleeve, and the pull rings extend along one side of the connecting sleeve away from the connecting shaft; the locking portion is configured to penetrate through the fixing component; the connecting sleeve and the connecting shaft are arranged in a relatively movable manner, so that the locking portion has a locked state of protruding from the fixing component and a contracted state of contracting inside the fixing component; and when the locking portion is in the locked state, the locking portion is connected to a to-be-connected component, so that the connecting structure is fixedly connected to the to-be-connected component.

Further, the connecting structure is provided with two fixing components, the two fixing components are spaced apart from each other, one end of the connecting shaft is connected to one fixing component, and the other end of the connecting shaft is connected to the other fixing component. Two pull rings are arranged, and one pull ring is connected to the connecting sleeve. Two locking portions are arranged, and the two locking portions and the two fixing components are arranged in one-to-one correspondence.

Further, the pull ring is arranged at one end of the connecting sleeve away from the fixing component.

Further, the connecting structure includes locking components, where the locking component is inserted the fixing component, the locking component is connected to the fixing component in a relatively movable manner, and the locking portion is arranged on the locking component. The connecting structure further includes elastic members, where the elastic member is sleeved on the locking component, one end of the elastic member is connected to the locking component, and the other end of the elastic member is connected to the connecting shaft.

Further, the fixing component is provided with a guide channel, the elastic member is arranged in the guide channel, and the locking component is inserted into the guide channel.

Further, threaded holes are formed inside the connecting sleeve, inner walls of the threaded holes are provided with internal threads, and external threads in fit with the internal threads are arranged on the locking component.

A transport cart includes the above connecting structure, and the transport cart includes: a carrying platform for carrying goods; a connecting frame, where the connecting frame is connected to the carrying platform, and connecting holes are formed on the connecting frame; and a push-pull frame that is connected to the connecting frame in a relatively rotatable manner. The connecting structure is arranged on the push-pull frame, and when the locking portion is in the locked state, the locking portion is inserted into the connecting hole.

Further, the push-pull frame includes: a handle connected to the connecting frame in a relatively rotatable manner; and a first connecting plate, where the first connecting plate is connected to the handle, a plurality of connecting holes are formed on the first connecting plate, and the plurality of connecting holes are arranged at intervals along the rotational axis of the handle.

Further, the connecting frame includes a first connecting frame and a second connecting frame. The transport cart further includes a connecting component. Both the first connecting frame and the second connecting frame are connected to the connecting component in a relatively rotatable manner, the connecting component is provided with two connecting structures arranged at intervals, and the first connecting frame and the second connecting frame are correspondingly arranged together with the two connecting structures on the connecting component respectively, so that the first connecting frame and/or the second connecting frame are fixed or released through the connecting structures on the connecting component.

Further, the transport cart includes rollers, and the rollers can be rotatably connected to the connecting component; and/or,

the push-pull frame includes a first push-pull frame and a second push-pull frame, where the first push-pull frame is connected to the first connecting frame, and the second push-pull frame is connected to the second connecting frame, while rotatable rollers are arranged on both the first connecting frame and the second connecting frame.

Beneficial effects:

1. The connecting structure of the present disclosure is capable of achieving stable connection with other components.

2. The transport cart of the present disclosure can be quickly disassembled and assembled with the connecting structure to realize the folding of the transport cart.

3. The transport cart of the present disclosure has a plurality of connecting holes connected to the connecting structure. A suitable transport cart can be assembled for transportation according to the size and quantity of the goods to be transported, and the use is flexible and changeable.

4. The transport cart of the present disclosure, when not in use, can be contracted by disassembling the connecting structure, thereby occupying a small space.

### BRIEF DESCRIPTION OF DRAWINGS

FIG. 1 is a schematic diagram of a connecting structure used in an embodiment of the present disclosure.

FIG. 2 is a schematic diagram of a view of a transport cart used in an embodiment of the present disclosure.

FIG. 3 is a partial enlarged view of a portion A in FIG. 2.

FIG. 4 is a schematic diagram of another view of a transport cart used in an embodiment of the present disclosure.

FIG. 5 is a schematic diagram of a transport cart in the first folded state used in an embodiment of the present disclosure.

FIG. 6 is a schematic diagram of a transport cart in the unfolded state used in an embodiment of the present disclosure.

FIG. 7 is a schematic diagram of a transport cart in the second folded state used in an embodiment of the present disclosure.

The above figures include the following reference numerals:

1, fixing component; 2, connecting shaft; 3, connecting sleeve; 31, pull ring; 32, locking portion; 33, support member; 4, locking component; 5, elastic member; 7, connecting hole; 8, connecting component; 10, carrying platform; 20, connecting frame; 201, first connecting frame; 202, second connecting frame; 30, push-pull frame; 301, handle; 302, first connecting plate; 303, first push-pull frame; 304, second push-pull frame; and 9, roller.

### DESCRIPTION OF EMBODIMENTS

In order to enable those skilled in the art to better understand the technical solutions of the present disclosure, the technical solutions in the embodiments of the present disclosure will be clearly and completely described below in combination with the accompanying drawings in the embodiments of the present disclosure. Apparently, the embodiments described are merely some rather than all of the embodiments of the present disclosure. Based on the embodiments of the present disclosure, all other embodiments acquired by those of ordinary skill in the art without making creative efforts fall within the scope of protection of the present disclosure.

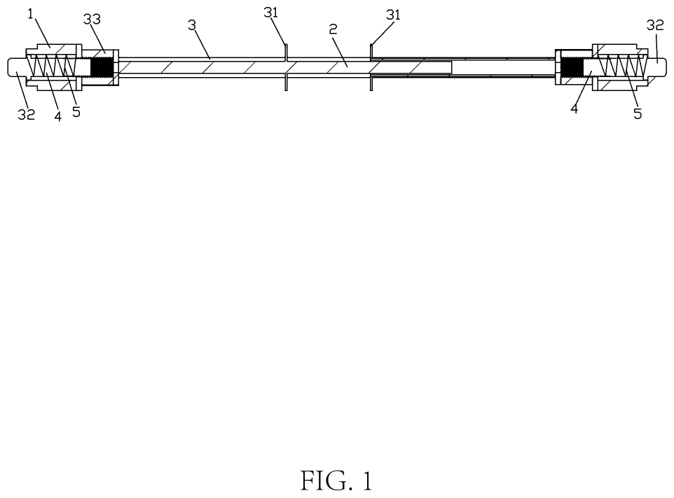

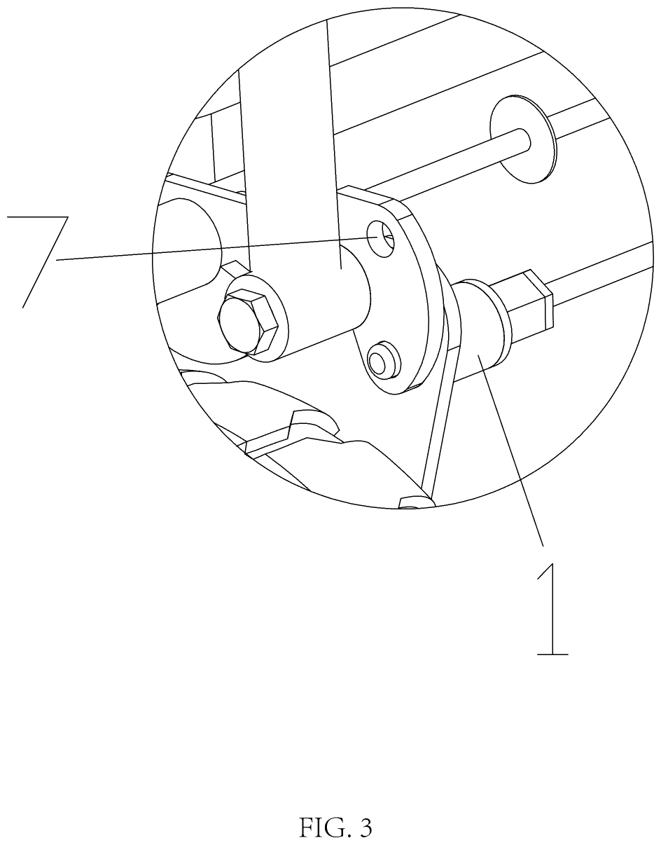

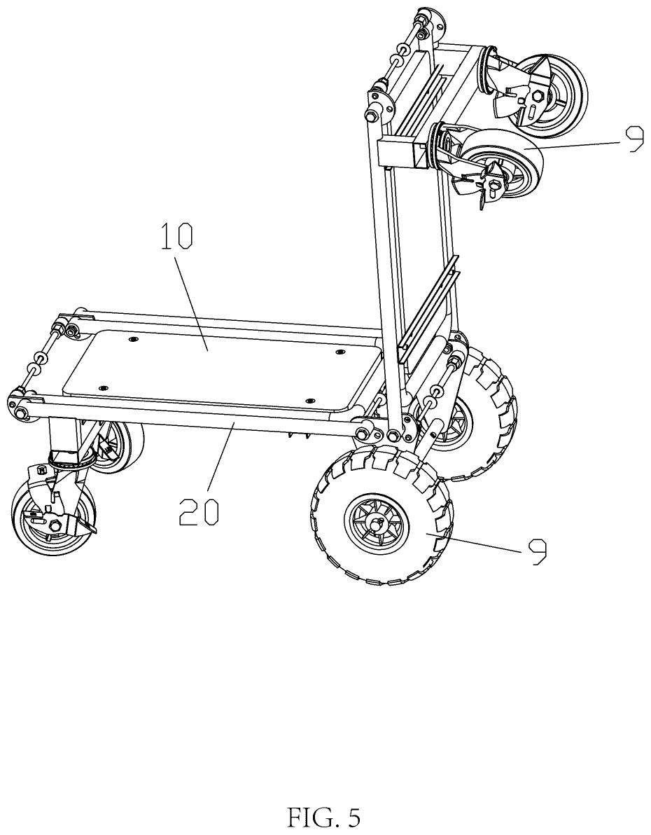

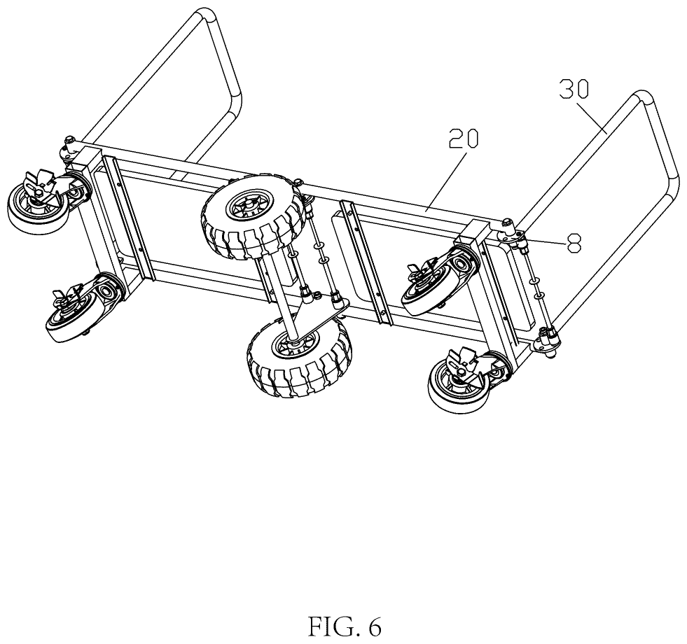

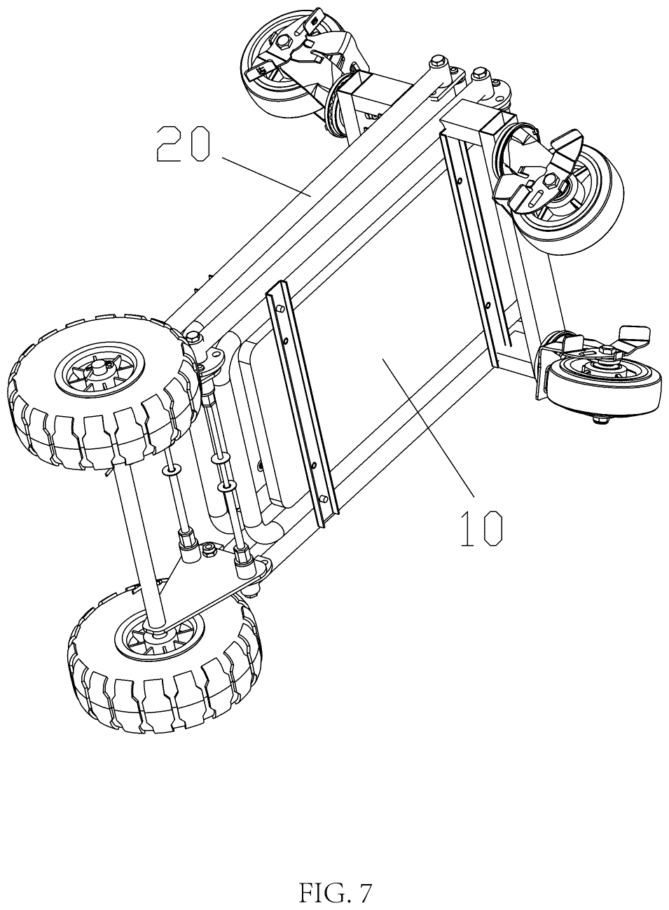

According to an embodiment of the present disclosure, a connecting structure is provided. With reference to FIGS. 1 to 7, the connecting structure includes: fixing components 1, a connecting shaft 2 that is connected to the fixing components 1, a connecting sleeve 3 that is sleeved on the connecting shaft 2, and pull rings 31 and locking portions 32 spaced apart from the pull rings 31 on the connecting sleeve 3, where the pull rings 31 are arranged around the connecting sleeve 3, and the pull rings 31 extend along one side of the connecting sleeve 3 away from the connecting shaft 2; the locking portion 32 is configured to penetrate through the fixing component 1; the connecting sleeve 3 and the connecting shaft 2 are arranged in a relatively movable manner, so that the locking portion 32 has a locked state of protruding from the fixing component 1 and a contracted state of contracting inside the fixing component 1; and when the locking portion 32 is in the locked state, the locking portion 32 is connected to a to-be-connected component, so that the connecting structure is fixedly connected to the to-be-connected component.

In the connecting structure of this embodiment, one end of the fixing component 1 is connected to the connecting shaft 2, the other end of the fixing component 1 is connected to the locking portion 32 that penetrates through the fixing component 1, and the locking portion 32 is capable of moving in the fixing component 1, so that the locking portion 32 has a locked state of protruding from the fixing component 1 and a contracted state of contracting inside the fixing component 1. The connecting sleeve 3 is sleeved on the connecting shaft 2, the pull rings 31 are arranged on one side of the connecting sleeve 3 away from the fixing component 1 and extend along one side of the connecting sleeve 3 away from the connecting shaft 2, and the connecting sleeve 3 and the connecting shaft 2 are arranged in a relatively movable manner. When the locking portion 32 is in the locked state, the locking portion 32 is connected to a to-be-connected component, so that the connecting structure is fixedly connected to the to-be-connected component; and when the locking portion 32 is in the contracted state, the locking portion 32 is disengaged from the to-be-connected component, so that the connecting structure is disengaged from the to-be-connected component. The fixing components 1 are configured to fix the locking portions 32, so that the locking portions 32, in either the locked state or the contracted state, are capable of maintaining the firmness of the connecting structure. The combined use of the connecting structure and a structure to be connected makes assembly and disassembly convenient, facilitates folding, and ensures the structure firmness during use. The connecting structure of the present disclosure solves the technical problem of instability of foldable connecting structures during use.

Specifically, the pull ring 31 is an annular structure, and the pull ring 31 is arranged around the connecting shaft 2.

Specifically, a support member 33 is arranged between the connecting sleeve 3 and the fixing component 1, the support member 33 is connected to the connecting sleeve 3, and the support member 33 and the fixing component 1 are arranged in a relatively movable manner. The outer diameter of the support member 33 is larger than the outer diameter of the connecting sleeve 3. When the locking portion 32 switches between the locked state and the contracted state, the connecting sleeve 3, through the support effect of the support member 33, abuts against and is disengaged from the fixing component 1, thus ensuring the stability of the connecting structure in the process of switching connection states.

With reference to FIG. 1, the connecting structure of this embodiment is provided with two fixing components 1, the two fixing components 1 are spaced apart from each other, one end of the connecting shaft 2 is connected to one fixing component 1, and the other end of the connecting shaft 2 is connected to the other fixing component 1. Two pull rings 31 are arranged, and one pull ring 31 is connected to the connecting sleeve 3 in one-to-one correspondence. Two locking portions 32 are arranged, and the two locking portions 32 and the two fixing components 1 are arranged in one-to-one correspondence.

Specifically, two locking portions 32, two fixing components 1 and two pull rings 31 are arranged. One end of the connecting shaft 2 is sequentially connected to one pull ring 31, one fixing component 1 and one locking portion 32, and the other end of the connecting shaft 2 is sequentially connected to the other pull ring 31, the other fixing component 1 and the other locking portion 32, thereby forming an axisymmetric structure with the axis of the connecting shaft 2 as the axis of symmetry. On one side of the axisymmetric structure, the connecting sleeve 3 is sleeved on the connecting shaft 2, and the connecting sleeve 3 is relatively movable on the connecting shaft 2. In use, the two locking portions 32 can be connected to two to-be-connected structures, and the axisymmetric structure ensures more stable connections.

Specifically, one pull ring 31 connected to the connecting sleeve 3 is capable of moving on the connecting shaft 2, and the other pull ring 31 is fixed on the connecting shaft 2. When pressing the locking portion 32, the pull ring 31 connected to the connecting sleeve 3 gradually approaches the other pull ring 31.

With reference to FIG. 1, in the connecting structure of this embodiment, the pull ring 31 is arranged at one end of the connecting sleeve 3 away from the fixing component 1. When the connecting sleeve 3 moves on the connecting shaft 2, the locking portion 32 on one end of the fixing component 1 is connected to the to-be-connected structure, and the other end thereof abuts against other components through the pull ring 31.

With reference to FIG. 1, the connecting structure of this embodiment includes locking components 4, where the locking component 4 is inserted the fixing component 1, the locking component 4 is connected to the fixing component 1 in a relatively movable manner, and the locking portion 32 is arranged on the locking component 4. The connecting structure further includes elastic members 5, where the elastic member 5 is sleeved on the locking component 4, one end of the elastic member 5 is connected to the locking component 4, and the other end of the elastic member 5 is connected to the connecting shaft 2. The locking component 4 is inserted into the fixing component 1, the locking portion 32 is arranged on the locking component 4, the locking component 4 is sleeved with an elastic member 5, one end of the elastic member 5 is connected to the locking component 4, and the other end of the elastic member 5 is connected to the connecting shaft 2.

Specifically, the support member 33 is sleeved with part of the elastic member 5. The elastic member 5 is capable of stretching and contracting inside the support member 33.

With reference to FIG. 1, in the connecting structure of this embodiment, the fixing component 1 is provided with a guide channel, the elastic member 5 is arranged in the guide channel, and the locking component 4 is inserted into the guide channel. The guide channel arranged in the fixing component 1 provides space for arrangement of the locking component 4 and the elastic member 5, one end of the elastic member 5 is connected to the connecting shaft 2, and the other end of the elastic member 5 is connected to the locking component 4, while the other end of the locking component 4 is connected to the locking portion 32. When the elastic member 5 is stretched or contracted in the guide channel, the connecting shaft 2 and the locking portion 32 on both ends thereof are driven to move, so that the connecting structure can be connected or disconnected with the to-be-connected structure.

With reference to FIG. 1, in the connecting structure of this embodiment, threaded holes are formed inside the connecting sleeve 3, inner walls of the threaded holes are provided with internal threads, and external threads in fit with the internal threads are arranged on the locking component 4.

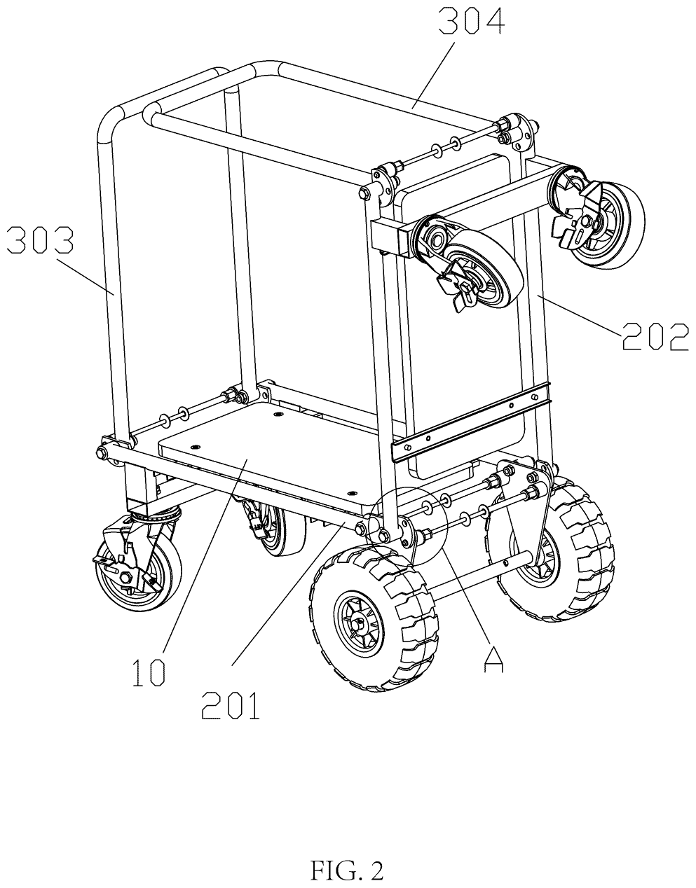

With reference to FIGS. 2 to 7, a transport cart of this embodiment includes the above connecting structure, and the transport cart includes: a carrying platform 10 for carrying goods; a connecting frame 20, where the connecting frame 20 is connected to the carrying platform 10, and connecting holes 7 are formed on the connecting frame 20; and a push-pull frame 30 that is connected to the connecting frame 20 in a relatively rotatable manner. The connecting structure is arranged on the push-pull frame 30, and when the locking portion 32 is in the locked state, the locking portion 32 is inserted into the connecting hole 7. The transport cart is provided with the carrying platform 10 for carrying goods, the connecting frame 20 is arranged around the carrying platform 10, the connecting holes 7 are formed on the connecting frame 20, the push-pull frame 30 is rotatably connected to the connecting frame 20, and the locking portion 32 of the connecting structure is inserted into the connecting hole 7, thereby achieving the connection between the connecting structure and the transport cart.

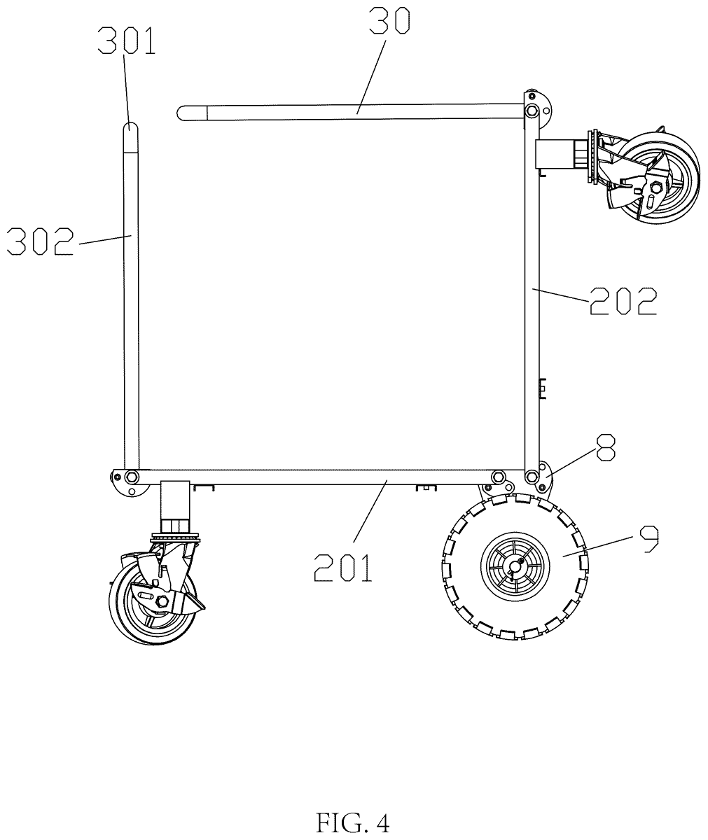

With reference to FIG. 4, in the transport cart of this embodiment, the push-pull frame 30 includes: a handle 301 connected to the connecting frame 20 in a relatively rotatable manner; and a first connecting plate 302, where the first connecting plate 302 is connected to the handle 301, a plurality of connecting holes 7 are formed on the first connecting plate 302, and the plurality of connecting holes 7 are arranged at intervals along the rotational axis of the handle 301. The plurality of connecting holes 7 are formed on the first connecting plate 302 of the push-pull frame 30, and the locking portion 32 of the connecting structure can be inserted into the connecting hole 7 according to actual situations. In order to facilitate the rotation of the push-pull frame 30, the plurality of connecting holes 7 are arranged along the rotational axis of the handle 301.

With reference to FIG. 4, in the transport cart of this embodiment, the connecting frame 20 includes a first connecting frame 201 and a second connecting frame 202. The transport cart further includes a connecting component 8. Both the first connecting frame 201 and the second connecting frame 202 are connected to the connecting component 8 in a relatively rotatable manner, the connecting component 8 is provided with two connecting structures arranged at intervals, and the first connecting frame 201 and the second connecting frame 202 are correspondingly arranged together with the two connecting structures on the connecting component 8 respectively, so that the first connecting frame 201 and the second connecting frame 202 are fixed or released through the connecting structures on the connecting component 8.

Specifically, the foldable transport cart includes the first connecting frame 201 and the second connecting frame 202, and the two connecting frames are connected by means of the connecting component 8 and connected to the connecting component 8 in a relatively rotatable manner. The connecting component 8 is provided with two connecting structures, and the connecting structures can be connected or disconnected with the to-be-connected structure through fixing or contracting of the locking portion 32. Similarly, the first connecting frame 201 and the second connecting frame 202 are connected by fixedly connecting the first connecting frame 201 and the second connecting frame 202 to the locking portion 32 of the connecting structure; or, the first connecting frame 201 and the second connecting frame 202 are disconnected by disconnecting the first connecting frame 201 and the second connecting frame 202 from the locking portion 32 of the connecting structure, so that the first connecting frame 201 and the second connecting frame 202 can be disassembled and assembled through the connecting structure, with features of flexible operation and easy folding.

In the transport cart of some embodiments, the first connecting frame 201 or the second connecting frame 202 can be fixed or released through the connecting structures on the connecting component 8. Through the connecting structure, the first connecting frame 201 or the second connecting frame 202 can also be fixed or released.

With reference to FIGS. 4 to 7, the transport cart of this embodiment includes rollers 9, and the rollers 9 can be rotatably connected to the connecting component 8. The push-pull frame 30 includes a first push-pull frame 303 and a second push-pull frame 304, where the first push-pull frame 303 is connected to the first connecting frame 201, and the second push-pull frame 304 is connected to the second connecting frame 202, while rotatable rollers 9 are arranged on both the first connecting frame 201 and the second connecting frame 202. The rollers 9 are installed on the transport cart, and are connected to the first connecting frame 201 and the second connecting frame 202 through the connecting component 8.

Specifically, the rollers 9 are divided into universal wheels and forwarding rollers. Suitable universal wheels and forwarding rollers are installed according to the usage state of the transport cart.

It should be noted that the terms “first”, “second”, etc. in the description, claims and above accompanying drawings are used to distinguish similar objects and are not necessarily intended to indicate a specific order or sequence. It should be understood that these terms can be interchanged in appropriate circumstances, so that the embodiments of the present disclosure described herein can be implemented in a different order than that illustrated or described herein. Further, the terms “including” and “having” and any variations thereof are intended to cover non-exclusive inclusion. For example, the process, method, system product or apparatus that comprises a series of steps or units does not necessarily include only those steps or units listed explicitly, but may include other steps or units that are not explicitly listed or are inherent to the process, method, product or apparatus.

Optionally, for the specific examples in this embodiment, reference can be made to the examples described in the above embodiments, and will not be repeated here in this embodiment.

The serial numbers of the embodiments of the present disclosure are for description only and do not represent the advantages or disadvantages of the embodiments.

In the above embodiments of the present disclosure, each embodiment is described with its own emphasis. For parts that are not described in detail in a certain embodiment, please refer to the relevant descriptions of other embodiments.

What is described above is merely the preferred implementation of the present disclosure. It should be noted that for those of ordinary skill in the art, they may make several improvements and modifications on the premise without deviating from a principle of the present disclosure, and these improvements and modifications shall fall within the protection scope of the present disclosure.

What is claimed is:

1. A connecting structure, comprising:
fixing components;
a connecting shaft that is connected to the fixing components;
a connecting sleeve that is sleeved on the connecting shaft, and pull rings and locking portions spaced apart from the pull rings on the connecting sleeve, wherein the pull rings are arranged around the connecting sleeve, and the pull rings extend along one side of the connecting sleeve away from the connecting shaft; the locking portion is configured to penetrate through the fixing component; and
the connecting sleeve and the connecting shaft are arranged in a relatively movable manner, so that the locking portion has a locked state of protruding from the fixing component and a contracted state of contracting inside the fixing component; and when the locking portion is in the locked state, the locking portion is connected to a to-be-connected component, so that the connecting structure is fixedly connected to the to-be-connected component.

2. The connecting structure according to claim 1, wherein the connecting structure is provided with two fixing components, the two fixing components are spaced apart from each other, one end of the connecting shaft is connected to one fixing component, and the other end of the connecting shaft is connected to the other fixing component; two pull rings are arranged, and one pull ring is connected to the connecting sleeve; and two locking portions are arranged, and the two locking portions and the two fixing components are arranged in one-to-one correspondence.

3. The connecting structure according to claim 2, wherein the pull ring is arranged at one end of the connecting sleeve away from the fixing component.

4. The connecting structure according to claim 1, comprising:
locking components, wherein the locking component is inserted into the fixing component, the locking component is connected to the fixing component in a relatively movable manner, and the locking portion is arranged on the locking component; and
elastic members, wherein the elastic member is sleeved on the locking component, one end of the elastic member is connected to the locking component, and the other end of the elastic member is connected to the connecting shaft.

5. The connecting structure according to claim 4, wherein the fixing component is provided with a guide channel, the elastic member is arranged in the guide channel, and the locking component is inserted into the guide channel.

6. The connecting structure according to claim 5, threaded holes are formed inside the connecting sleeve, inner walls of the threaded holes are provided with internal threads, and external threads in fit with the internal threads are arranged on the locking component.

7. A transport cart, comprising the connecting structure of claim 1, wherein the transport cart comprises:
a carrying platform for carrying goods;
a connecting frame, wherein the connecting frame is connected to the carrying platform, and connecting holes are formed on the connecting frame; and
a push-pull frame that is connected to the connecting frame in a relatively rotatable manner; the connecting structure is arranged on the push-pull frame, and when the locking portion is in the locked state, the locking portion is inserted into the connecting hole.

8. The transport cart according to claim 7, wherein the push-pull frame comprises:
a handle connected to the connecting frame in a relatively rotatable manner;
and a first connecting plate, wherein the first connecting plate is connected to the handle, a plurality of connecting holes are formed on the first connecting plate, and the plurality of connecting holes are arranged at intervals along the rotational axis of the handle.

9. The transport cart according to claim 7, wherein the connecting frame comprises a first connecting frame and a second connecting frame, and the transport cart further comprises:
a connecting component, wherein both the first connecting frame and the second connecting frame are connected to the connecting component in a relatively rotatable manner, the connecting component is provided with two connecting structures arranged at intervals, and the first connecting frame and the second connecting frame are correspondingly arranged together with the two connecting structures on the connecting component respectively, so that the first connecting frame and/or the second connecting frame are fixed or released through the connecting structures on the connecting component.

10. The transport cart according to claim 9, wherein
the transport cart comprises rollers, and the rollers can be rotatably connected to the connecting component; and/or,
the push-pull frame comprises a first push-pull frame and a second push-pull frame, wherein the first push-pull frame is connected to the first connecting frame, and the second push-pull frame is connected to the second connecting frame, while rotatable rollers are arranged on both the first connecting frame and the second connecting frame.
